(19) United States
(12) Patent Application Publication
(10) Pub. No.: US 2013/0104177 A1
(43) Pub. Date: Apr. 25, 2013

(54) DISTRIBUTED REAL-TIME VIDEO PROCESSING

(71) Applicants: Gavan Kwan, Mountain View, CA (US); Alan deLespinasse, Somerville, MA (US); John Gregg, Seattle, WA (US); Rushabh Doshi, Menlo Park, CA (US)

(72) Inventors: Gavan Kwan, Mountain View, CA (US); Alan deLespinasse, Somerville, MA (US); John Gregg, Seattle, WA (US); Rushabh Doshi, Menlo Park, CA (US)

(73) Assignee: GOOGLE INC., Mountain View, CA (US)

(21) Appl. No.: 13/276,578

(22) Filed: Oct. 19, 2011

(51) Int. Cl. H04N 21/23

(52) U.S. Cl. 725/93

(57) ABSTRACT

A system and method provide distributed real-time video processing. The distributed real-time video processing method comprises receiving a request for processing a video and determines one or more processing parameters based on the request. The method partitions the video into a sequence comprising multiple video chunks, where a video chunk identifies a portion of video data of the video for processing. The method further transmits the processing parameters associated with one or more video chunks for parallel processing. The method processes the video chunks in parallel and accesses the processed video chunks. The method assembles the processed video chunks and provides the assembled video chunks responsive to the request.

### BACKGROUND

Described embodiments relate generally to streaming data processing, and more particularly to distributed real-time video processing.

Video processing includes a process of generating an output video with desired features or visual effects from a source, such as a video file, computer model, or the like. Video processing has a wide range of applications in movie and TV visual effects, video games, architecture and design among other fields. For example, some video hosting services, such as YOUTUBE, allow users to post or upload videos including user edited videos, each of which combines one or more video clips. Most video hosting services process videos by transcoding an original source video from one format into another video format appropriate for further processing (e.g., video playback or video streaming). Video processing often comprises complex computations on a video file, such as camera motion estimation for video stabilization across multiple video frames, which is computationally expensive. Video stabilization smoothes the frame-to-frame jitter caused by camera motion (e.g., camera shaking) during video capture.

One challenge in designing a video processing system for video hosting services with a large number of videos is to process and to store the videos with acceptable visual quality and at a reasonable computing cost. Real-time video processing is even more challenging because it adds latency and throughput requirements specific to real-time processing. A particular problem for real-time video processing is to handle arbitrarily complex video processing computations for real-time video playback or streaming without stalling or stuttering while still maintaining low latency. For example, for user uploaded videos, it is not acceptable to force a user to wait a minute or longer before having the first frame data available from video processing process in real-time video streaming. Existing real-time video processing systems may do complex video processing dynamically, but often at expense of adding a large start-up latency, which degrades user experience in video uploading and streaming.

### SUMMARY

A method, system and computer program product provides distributed real-time video processing.

In one embodiment, the distributed real-time video processing system comprises a video server, a system load balancer, multiple video processing units and a pool of workers for providing video processing services in parallel. The video server receives user video processing requests and sends the video processing requests to the system load balancer for distribution to the video processing units. The system load balancer receives video processing requests from the video server, and distributes the requests among the video processing units. Upon receiving the video processing requests, the video processing units can concurrently process the video processing requests. A video processing unit receives a video processing request from the system load balancer and provides the requested video processing service performed by multiple workers in parallel to the sender of the video processing request or to the next processing unit (e.g., a video streaming server) for further processing.

Another embodiment includes a computer method for distributed real-time video processing. A further embodiment includes a non-transitory computer-readable medium that stores executable computer program instructions for processing a video in the manner described above.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

While embodiments are described with respect to processing video, those skilled in the art would come to realize that the embodiments described herein may be used to process audio, or any other suitable media.

### BRIEF DESCRIPTION OF THE FIGURES

FIG. 1 is a block diagram illustrating a distributed real-time video processing system.

FIG. 2 is a block diagram of a preview server of the distributed real-time processing system illustrated in FIG. 1.

FIG. 3 is a flow diagram of interactions among a preview server, a chunk distributor and a pool of workers of the distributed real-time processing system illustrated in FIG. 1.

FIG. 4 is an example of distributing multiple chunks of a video for real-time video processing using a sliding window.

FIG. 5 is an example of a video partitioned into multiple video chunks for video processing.

The figures depict various embodiments of the invention for purposes of illustration only, and the invention is not limited to these illustrated embodiments. One skilled in the art will readily recognize from the following discussion that alternative embodiments of the structures and methods illustrated herein may be employed without departing from the principles of the invention described herein.

### DETAILED DESCRIPTION

### I. System Overview

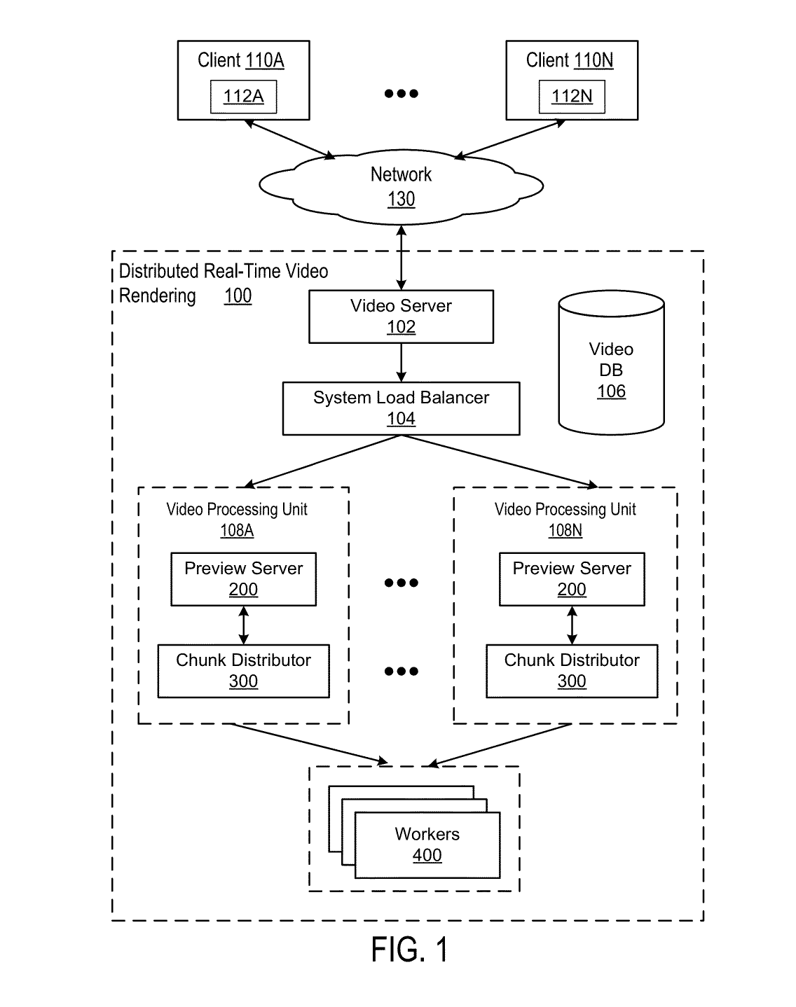

FIG. 1 is a block diagram illustrating a distributed real-time video processing system 100. Multiple users/viewers use client 110A-N to send video processing requests to the distributed real-time video processing system 100. The video processing system 100 communicates with one or more clients 110A-N via a network 130. The video processing system 100 receives the video processing service requests from clients 110A-N, processes the videos identified in the processing service requests and returns the processed videos to the clients 110A-N or to other services processing units (e.g., video streaming servers for streaming the processed videos). The distributed real-time video processing system 100 can be a part of a cloud computing system.

Turning to the individual entities illustrated on FIG. 1, each client 110 is configured for use by a user to request video processing services. The client 110 can be any type of computer device, such as a personal computer (e.g., desktop, notebook, laptop) computer, as well as devices such as a mobile telephone, personal digital assistant, IP enabled video player. The client 110 typically includes a processor, a display device (or output to a display device), a local storage, such as a hard drive or flash memory device, to which the client 110 stores data used by the user in performing tasks, and a network interface for coupling to the system 100 via the network 130.

A client 110 may have a video editing tool 112 for editing video files. Video editing at the client 110 may include generating a composite video by combining multiple video clips or dividing a video clip into multiple individual video clips. For a video having multiple video clips, the video editing tool 112 at the client 110 generates an edit list of video clips, each of which is uniquely identified by an identification. The edit list of video clips also includes description of the source of the video clips, such as the location of the video server storing the video clip. The edit list of the video clips may further describe the order of the video clips in the video, length of each video clip (measured in time or number of video frames), starting time and ending time of each video clip, video format (e.g., H.264), specific instruction for video processing and other metadata describing the composition of the video.

The video editing tool 112 may be a standalone application, or a plug-in to another application such as a network browser. Where the client 110 is a general purpose device (e.g., a desktop computer, mobile phone), the video editing tool 112 is typically implemented as software executed by a processor of the computer. The video editing tool 112 includes user interface controls (and corresponding application programming interfaces) for selecting a video feed, starting, stopping, and combining a video feed. Other types of user interface controls (e.g., buttons, keyboard controls) can be used as well to control the video editing functionality of the video editing tool 112.

The network 130 enables communications between the clients 110 and the distributed real-time video processing system 100. In one embodiment, the network 130 is the Internet, and uses standardized internetworking communications technologies and protocols, known now or subsequently developed that enable the clients 110 to communicate with the distributed real-time video processing system 100.

The distributed real-time video processing system 100 has a video server 102, a system load balancer 104, a video database 106, one or more video processing units 108A-N and a pool of workers 400. The video server 102 receives user video processing requests and sends the video processing requests to the system load balancer 104 for distribution to the video processing units 108A-N. The video server 102 can also function as a video streaming server to stream the processed videos to clients 110. The video database 106 stores user uploaded videos and videos from other sources. The video database 106 also stores videos processed by the video processing units 108A-N.

The system load balancer 104 receives video processing requests from the video server 102, and distributes the requests among the video processing units 108A-N. In one embodiment, the system load balancer 104 routes the requests to the video processing units 108A-N using a round robin routing algorithm. Other load balancing algorithms known to those of ordinary skill in the art are also within the scope of the invention. Upon receiving the video processing requests, the video processing units 108A-N can parallel process the video processing requests.

A video processing unit 108 receives a video processing request from the system load balancer 104 and provides the requested video processing service performed by multiple workers in parallel to the sender of the video processing request or to the next processing unit (e.g., a video streaming server) for further processing. Multiple video processing units 108A-N share the pool of workers 400 for providing video processing services. In another embodiment, each of the video processing units 108A-N has its own pool of workers 400 for video processing services.

In one embodiment, a video processing unit 108 has a preview server 200 and a chunk distributor 300. For a video processing request received by the video processing unit 108, the preview server 200 determines video processing parameters and partitions the video identified in the processing request into multiple temporal sections (also referred to as “video processing chunks” or “chunks” from herein). The preview server 200 sends a request to the chunk distributor 300 requesting a number of workers 400 to provide the video processing service. The chunk distributor 300 selects the requested number of workers 400 and returns the selected workers 400 to the preview server 200. The preview server 200 sends the video processing parameters and the video processing chunks information to the selected workers 400 for performing the requested video processing service in parallel. The preview server 200 passes video processing parameters and video chunks information to the selected workers 400 through remote procedure calls (RPCs). In alternative embodiments, the functionality associated with the chunk distributor 300 may be incorporated into the system load balancer 104 (FIG. 1).

A worker 400 is a computing device. A number of workers 400 selected by a chunk distributor 300 perform video processing tasks (e.g., video rendering) described by the processing parameters associated with the video processing tasks. For example, for video stabilization, which requires camera motion estimation, the selected workers 400 identify objects among the video frames and calculate the movement of the objects across the video frames. The workers 400 return the camera motion estimation to the preview server 200 for further processing.

### II. Distributed Real-Time Video Processing

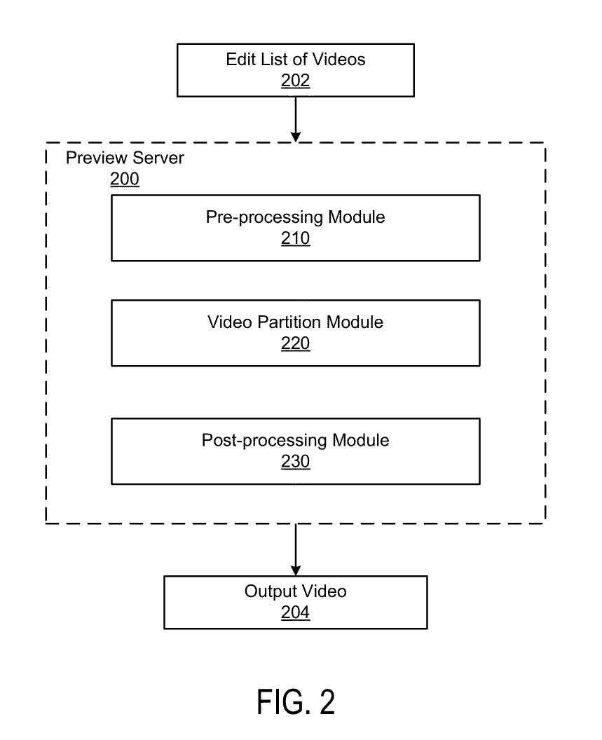

FIG. 2 is a block diagram of a preview server 200 of the distributed real-time processing system 100, according to an illustrative embodiment. In the embodiment illustrated in FIG. 2, the preview server 200 has a pre-processing module 210, a video partitioning module 220 and a post-processing module 230. The preview server 200 receives an edit list of videos 202 for video processing service, determines the video processing parameters and partitions the videos of the edit list 202 into multiple video chunks. The preview server 200 communicates with one or more selected workers 400 for processing the videos and accesses the processed video chunks to generate an output video 204.

In one embodiment, the edit list of videos 202 contains a description for video processing service. The video can be a composite video consisting of one or more video clips or a video divided into multiple video clips. Taking a composite video as an example, the description describes a list of video clips contained in the composite video. Each of the video clips is uniquely identified by an identification (ID) (e.g., system generated file name or ID number for the video clip). The description also identifies the source of each video clip, such as the location of the video server storing the video clip, and type of video clips. The description may further describe the order of the video clips in the composite video, length of each video clip (measured in time or number of video frames), starting time and ending time of each video clip, video format (e.g., H.264 codec) and other metadata describing the composition of the composite video.

The pre-processing module 210 of the preview server 200 receives the edit list of videos 202 and determines the video processing parameters from the description contained in the edit list 202. The processing parameters describe how to process the video frames in a video clip. For example, the video processing parameters include the number of video clips in a composite video, number of frames for each video clip, timestamps (e.g., starting time and ending time of each video clip) and types of video processing operations requested (e.g., stabilization of video camera among the video frames of a video clip, color processing, etc.). The pre-processing module 210 maps the unique identification of each video clip to a video storage (e.g., the video database 106 illustrated in FIG. 1) and retrieves and stores the identified videos to a local storage associated with the video processing unit 108 for further processing. The pre-processing module 210 communicates with the video partition module 220 to partition the video clips identified in the edit list of videos 202.

Varying contents in scenes captured in a video contain various amount of information in the video. Variations in the spatial and temporal characteristics of a video lead to different coding complexity of the video. In one embodiment, pre-processing module 210 estimates the complexity of a video for processing based on one or more spatial and/or temporal features of the video. For example, the complexity estimation of a video is computed based on frame-level spatial variance, residual energy, number of skipped macroblocks (MBs) and number of bits to encode the motion vector of a predictive MB of the video. Other coding parameters, such as universal workload of encoding the video, can be used in video complexity estimation. The video partition module 220 can use the video complexity estimation to guide video partitioning.

The video partition module 220 partitions a video clip identified in the edit list of videos 202 into one or more video processing chunks at the appropriate frame boundaries. A video processing chunk is a portion of the video data of the video clip. A video processing chunk is identified by a unique chunk identification (e.g., vc_id_1) and the identification for a subsequent video chunk in the sequence of the video processing chunks is incremented by a fixed amount (e.g., vc_id_2).

The video partition module 220 can partition a video clip in a variety of ways. In one embodiment, the video partition module 220 can partition a video clip into fixed sized video chunks. The size of a video chunk is balanced between video processing latency and system performance. For example, every 15 seconds of the video data of the video clip form a video chunk. The fixed size of each video chunk can also be measured in terms of number of video frames. For example, every 100 frames of the video clip forms a video chunk.

In another embodiment, the video partition module 220 partitions the video clip into variable sized video chunks, for example, based on the variation and complexity of motion in the video clip. For example, assume the first 5 seconds of the video data of the video clip contain complex video data (e.g., a football match) and the subsequent 20 seconds of the video data are simple and static scenes (e.g., green grass of the football field). The first 5 seconds of the video forms a first video chunk and the subsequent 20 seconds of the video clip make a second video chunk. In this manner, the latency associated with rendering the video clips is reduced.

Alternatively, the video partition module 220 partitions a video clip into multiple one-frame video chunks, where each video chunk corresponds to one video frame of the video clip. This type of video processing is referred to as “single-frame processing.” One-frame video chunk partition is suitable for a video processing task that processes each video frame independently from its temporally adjacent video frames. One benefit of partitioning a video clip into one-frame video chunks is some amount of computing overhead can be saved, and latency reduced by not having to reinitialize the workers 400, and can be used to optimize specific video processing tasks that do not require information across the video frames of a video clip.

Another type of video processing requires multiple frames of an input video to generate a target frame. This type of processing is referred to as “multi-frame processing.” It is more optimal to use larger chunk sizes for multi-frame processing because the same frame information is not sent multiple times. Choosing larger chunk sizes may cause increased latency to a user, as the video process system 100 cannot start streaming the video until processing of the first chunk completes. Care needs to be taken to balance the efficiency of the video processing system with the responsiveness of the video processing service. For example, the video partition module 220 can choose smaller chunk size at the start of video streaming to reduce initial latency and choose larger chunk size later to increase efficiency of the video processing system.

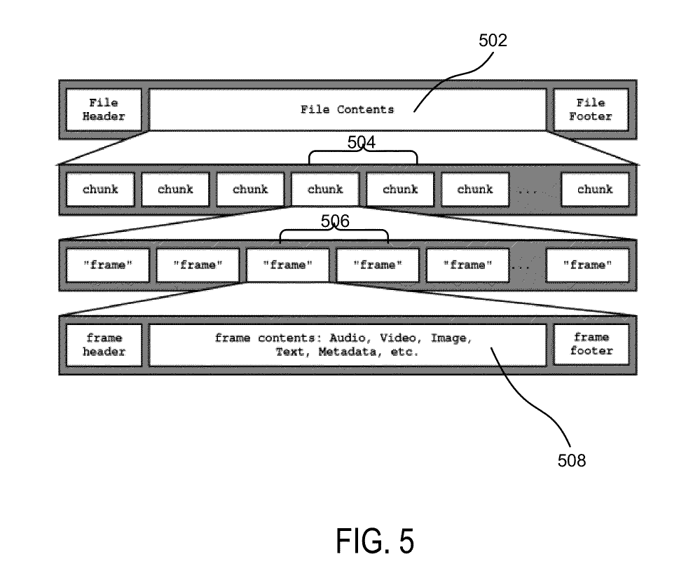

To further illustrate the video clip partitioning by the video partition module 220, FIG. 5 is an example of a video clip partitioned into multiple video chunks. In the example illustrated in FIG. 5, a generic container file format is used to encapsulate the underlying video data or audio data of a video clip to be partitioned. The example generic file format includes an optional file header followed by file contents 502 and an optional file footer. The file contents 502 comprise a sequence of zero or more video processing chunks 504, and each chunk is a sequence of frames 506. Each frame 506 includes an optional frame header followed by frame contents 508 and an optional frame footer. A frame 506 can be of any type, for example, audio, video or both. For temporal media, e.g., audio or video, frames are defined by a specific (e.g., chronological) timestamp.

For each frame 506, a timestamp can be computed. A timestamp need not necessarily correspond to a physical time, and should be thought of as an arbitrary monotonically increasing value that is assigned to each frame of each stream in the file. If a timestamp is not directly available, the timestamp can be synthesized through interpolation according to the parameters of the video file. Each frame 506 is composed of data, typically compressed audio, compressed video, text metadata, binary metadata, or of any other arbitrary type of compressed or uncompressed data.

Referring back to FIG. 2, the post-processing module 230 accesses video chunks processed by the workers 400. Upon receiving a completed video chunk form a worker 400, the post-processing module 230 sends a request for processing next video chunk to the chunk distributor 300. For example, as soon as the first video chunk processing completes and returns, the post-processing module 230 has enough data to process the first video frame. As each video chunk completes, the post-processing module 230 requests an additional video chunk for processing. For example, in response to receiving the worker 400 selected by the chunk distributor 300 for processing a video chunk, the post-processing module 230 passes processing parameters associated with the video chunk to the selected worker 400 for processing service. Upon completion of one or more video chunks of a video clip, the post-processing module 230 forms the output video 204 and sends the output video 204 to a streaming server for video streaming.

Distributing the video chunks in an appropriate order and distributing an appropriate number of video chunks to workers 400 at a time allow the distributed real-time processing system 100 (FIG. 1) to meet the latency requirement for real-time processing. For example, distributing too many video chunks at the start would potentially overload the workers 400. Distributing too few video chunks to the workers 400 would potentially result in not enough video frames being processed in time for real-time streaming of the processed video. Additionally, distributing a group of video chunks in order helps the real-time video streaming of the processed video because the preview server 200 accesses the completed video chunks in order. Workers 400 may balance the workload of processing the video chunks among themselves. For example, a worker 400 may distribute some of its workload to other workers 400, which process the received workload in parallel.

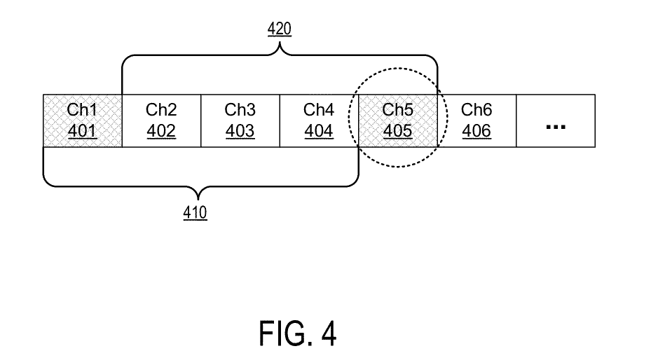

In one embodiment, the post-processing module 230 uses a sliding window to control the video chunk distribution through the chunk distributor 300. The window size represents the number of video chunks being processed in parallel at a time by the selected workers 400. FIG. 4 is an example of distributing multiple chunks of a video processing task using a sliding window. In the embodiment illustrated in FIG. 4, the size of the sliding window is four, which means four video chunks 401-404 are distributed through the chunk distributor 300 to one or more workers 400 for parallel video processing service.

Assume that the sliding window 410 includes the first group of four video chunks distributed to four workers 400 for processing. The order of the four video chunks 401-403 corresponds to the order of streaming the completed video chunks. In other words, the first video chunk 401 needs to be completed before any other video chunks (402-403) for video streaming. Given the workers 400 processing their assigned video chunks can have different work loads and processing speeds, the post-processing module 230 controls the order of the completed video chunks by accessing the completed video chunks in order. In other words, the post-processing module 230 accesses completed video chunk 401 before accessing the completed video chunk 403 even if the worker 400 responsible for the video chunk 403 finishes the processing before the worker 400 responsible for the video chunk 401.

Responsive to the first video chunk 401 being completed and returned by the worker 400, the post-processing module 230 requests next video chunk 405 for processing. The updated sliding window 420 now includes video chunks 402-405. The chunk distributor 300 selects a worker 400 for processing video chunk 405. The sliding window slides along the video chunks until all video chunks are processed.

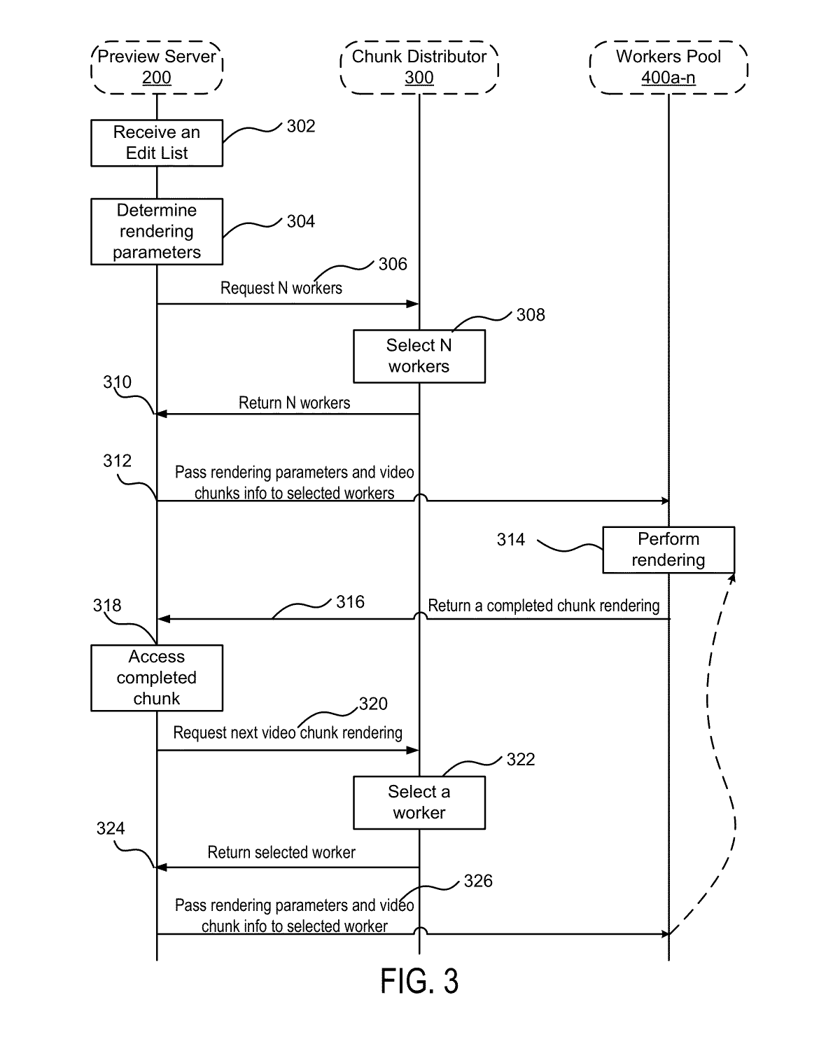

FIG. 3 is a flow diagram of interactions among a preview server 200, a chunk distributor 300 and a pool of workers 400 of the distributed real-time processing system 100. The interactions illustrated in FIG. 3 are example interactions among a preview server 200, a chunk distributor 300 and a pool of workers 400 of the distributed real-time processing system 100. The same or similar operation is happening concurrently for each of the video processing units 108A-N of the distributed real-time processing system 100. This facilitates the parallel processing of many different videos. Initially, the preview server 200 receives 302 an edit list of videos from the system load balancer 104. The preview server 200 determines 304 the processing parameters (e.g., number of video frames of each video clip and source of the video clip and type of video processing service requested). The preview server 200 partitions the video clip identified in the edit list into multiple video chunks and requests 306 a number (e.g., N) of workers 400 for the processing task from the chunk distributor 300.

In one embodiment, the number of workers 400 requested, e.g., N, is determined as a function of parameters such as total number of video frames, groups of pictures (GOPs) of the video clip and size of video chunks. For example, a video clip contains multiple GOPs, each of which has 30 video frames of the video clip. The minimum size of a video chunk can be four GOPs (i.e., about 120 frames) and each video chunk is processed by a worker 400. In this scenario, N is equal to the number of video chunks constrained by the size of the sliding window (e.g., sliding window 410 of FIG. 4).

The chunk distributor 300 selects 308 the requested number of workers 400. The chunk distributor 300 uses round robin scheme or other schemes (e.g., load of a worker 400) to select the requested number of workers 400. The chunk distributor 300 returns 310 the identifications of the selected workers 400 to the preview server 200.

The preview server 200 passes 312 the processing parameters and video chunk information for the first N chunks to respective ones of the N selected workers 400. For example, the preview server 200 passes the processing parameters and video chunk information via remote procedure calls to the workers 400. The selected workers 400 perform 314 the processing of the video chunks substantially in parallel. Upon completion of processing a video chunk, the worker 400 responsible for the video chunk returns 316 the completed video chunk to the preview server 200. The worker 400 can return 316 the chunk using a callback function, or other information passing method.

In response to receiving a completed video chunk from the worker 400, the preview server 200 accesses 318 the completed video chunk and processes the video frames in the video chunk for video streaming. Additionally, the preview server 200 requests 320 processing another video chunk via the chunk distributor 300. The preview server 200 can use a sliding window to control the order of processing and amount of video chunks being processed at a given time. The chunk distributor 300 selects 322 an available worker 400 for the new video chunk requested by the preview server 200 and returns 324 the identification of the selected worker 400 to the preview server 200. The preview server 200 passes 326 the processing parameters associated with the new video chunk to the selected worker 400, which performs the requested video processing task. The operations by the preview server 200, the chunk distributor 300 and the selected workers 400 as described above repeat until the all the video chunks are processed. As discussed above with respect to FIG. 2, upon processing of one or more video chunks of a video clip, the post-processing module 230 (FIG. 2) forms output video 204 and sends the output video 204 to a streaming server for video streaming.

The above description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention. For example, the operation of the preferred embodiments illustrated above can be applied to other media types, such as audio, text and images.

The invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the invention include process steps and instructions described herein in the form of an algorithm. It should be noted that the process steps and instructions of the invention could be embodied in software, firmware or hardware, and when embodied in software, could be downloaded to reside on and be operated from different platforms used by real time network operating systems.

The invention also relates to an apparatus for performing the operations herein. This apparatus may be specially constructed for the required purposes, or it may comprise a general-purpose computer selectively activated or reconfigured by a computer program stored on a computer readable storage medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the method steps. The structure for a variety of these systems will be apparent to those of skill in the art, along with equivalent variations. In addition, the invention is not described with primary to any particular programming language. It is appreciated that a variety of programming languages may be used to implement the teachings of the invention as described herein, and any reference to specific languages are provided for disclosure of enablement and best mode of the invention.

The invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the invention is intended to be illustrative, but not limiting, of the scope of the invention, which is set forth in the following claims.

1. A computer method for providing distributed real-time video processing, the method comprising:
receiving a request for processing a video, the video comprising a plurality of video frames;
determining one or more processing parameters based on the request, the processing parameters indicating at least one processing operation to perform on the video;
partitioning the video into a sequence comprising a plurality of video chunks, a video chunk identifying a portion of video data of the video for processing;
determining a number of computing devices for parallel processing of the video chunks, the number of video computing devices being determined as a function of at least one of number of group of pictures and size of a video chunk, a computing device having a plurality of video processing modules configured to process the video chunks assigned to the computing device, the plurality of video processing modules configured to balance the workload of processing video chunks in parallel;
selecting the determined number of computing devices and distributing the plurality of video chunks and the processing parameters associated with the video chunks to the computing devices for parallel processing of the video chunks according to the indicated processing operation;
parallel processing the video chunks by the computing devices according to the indicated processing operation, wherein each computing device produces a processed video chunk;
accessing the video chunks processed by the selected computing devices in an order based on work load and processing speed of the selected computing devices; and
assembling the processed video chunks according to the sequence.

2. The method of claim 1, wherein one or more processing parameters comprise:
type of processing service requested;
number of video frames in the video, each video frame in the video having a starting time and an ending time;
identification of the video;
video format; and
source of the video.

3. The method of claim 1, wherein partitioning the video comprises partitioning the video into fixed sized video chunks.

4. The method of claim 1, wherein partitioning the video comprises partitioning the video into variable sized video chunks based at least in part on a coding complexity measure of the video.

5. The method of claim 1, wherein accessing the video chunks processed by the one or more selected computing devices comprises accessing the processed video chunks in a pre-determined order.

6. The method of claim 1, further comprising:
requesting the number of computing devices for processing a set of video chunks in parallel; and
receiving the requested number of computing devices selected for processing the set of video chunks in parallel.

7. The method of claim 6, wherein the number of computing devices is determined based at least in part on the type of processing services requested.

8. The method of claim 6, further comprising using a sliding window to control the number of video chunks to be processed in parallel.

9. The method of claim 1, wherein the type of video processing service in the request is stabilizing camera motion among the video frames of the video.

10. The method of claim 9, wherein stabilizing camera motion among the video frames of the video comprises applying camera motion estimation to the video frames of the video, the camera motion being estimated by the selected computing devices processing the video chunks of the video.

11. The method of claim 1, further comprising providing the assembled video chunks responsive to a request.

12. The method of claim 1, wherein the video is a user uploaded video.

13. A non-transitory computer-readable storage medium storing executable computer program instructions for providing distributed real-time video processing, the computer program instructions comprising instructions for:
receiving a request for processing a video, the video comprising a plurality of video frames;
determining one or more processing parameters based on the request, the processing parameters indicating at least one processing operation to perform on the video;
partitioning the video into a sequence comprising a plurality of video chunks, a video chunk identifying a portion of video data of the video for processing;
determining a number of computing devices for parallel processing of the video chunks, the number of video computing devices being determined as a function of at least one of number of group of pictures and size of a video chunk, a computing device having a plurality of video processing modules configured to process the video chunks assigned to the computing device, the plurality of video processing modules configured to balance the workload of processing video chunks in parallel;
selecting the determined number of computing devices and distributing the plurality of video chunks and the processing parameters associated with the video chunks to the computing devices for parallel processing of the video chunks according to the indicated processing operation;
parallel processing the video chunks by the computing devices according to the indicated processing operation, wherein each computing device produces a processed video chunk;
accessing the video chunks processed by the selected computing devices in an order based on work load and processing speed of the selected computing devices; and
assembling the processed video chunks according to the sequence.

14. The computer-readable storage medium of claim 13, wherein one or more processing parameters comprise:
type of processing service requested;
number of video frames in the video, each video frame in the video having a starting time and an ending time;
identification of the video;
video format; and
source of the video.

15. The computer-readable storage medium of claim 13, wherein the computer program instructions for partitioning the video comprise instructions for partitioning the video into fixed sized video chunks.

16. The computer-readable storage medium of claim 13, wherein the computer program instructions for partitioning the video comprise instructions for partitioning the video into variable sized video chunks based at least in part on a coding complexity measure of the video.

17. The computer-readable storage medium of claim 13, wherein the computer program instructions for accessing the video chunks processed by the one or more selected computing devices comprise instructions for accessing the processed video chunks in a pre-determined order.

18. The computer-readable storage medium of claim 13, further comprising computer program instructions for:
requesting the number of computing devices for processing a set of video chunks in parallel; and
receiving the requested number of computing devices selected for processing the set of video chunks in parallel.

19. The computer-readable storage medium of claim 16, further comprising computer program instructions for using a sliding window to control the number of video chunks to be processed in parallel.

20. The computer-readable storage medium of claim 13, wherein the type of video processing service in the request is stabilizing camera motion among the video frames of the video.

21. The computer-readable storage medium of claim 20, wherein the computer program instructions for stabilizing camera motion among the video frames of the video comprise instructions for applying camera motion estimation to the video frames of the video, the camera motion being estimated by the selected computing devices processing the video chunks of the video.

22. The computer-readable storage medium of claim 13, further comprising computer program instructions for providing the assembled video chunks responsive to a request.

23. (canceled)

24. A computer system for providing distributed real-time video processing, the system comprising:
a pre-processing module for:
receiving a request for processing a video, the video comprising a plurality of video frames; and
determining one or more processing parameters based on the request, the processing parameters indicating at least one processing operation to perform on the video;
a video partition module for:
partitioning the video into a sequence comprising a plurality of video chunks, a video chunk identifying a portion of video data of the video for processing;
determining a number of computing devices for parallel processing of the video chunks, the number of video computing devices being determined as a function of at least one of number of group of pictures and size of a video chunk, a computing device having a plurality of video processing modules configured to process the video chunks assigned to the computing device, the plurality of video processing modules configured to balance the workload of processing video chunks in parallel;
selecting the determined number of computing devices and distributing the plurality of video chunks and the processing parameters associated with the video chunks to the selected computing devices for parallel processing of the video chunks according to the indicated processing operation;
a post-processing module for:
parallel processing the video chunks by the computing devices according to the indicated processing operation, wherein each video processing unit produces a processed video chunk;
accessing the video chunks processed by the selected computing devices in an order based on work load and processing speed of the selected computing devices; and
assembling the processed video chunks according to the sequence.

25. The system of claim 24, wherein one or more processing parameters comprise:
type of processing service requested;
number of video frames in the video, each video frame in the video having a starting time and an ending time;
identification of the video;
video format; and
source of the video.

26. The system of claim 24, wherein the video partition module is further for:
requesting the number of computing devices for processing a set of video chunks in parallel; and
receiving the requested number of computing devices selected for processing the set of video chunks in parallel.

27. The system of claim 26, wherein the video partition module is further for using a sliding window to control the number of video chunks to be processed in parallel.

28. The system of claim 24, wherein the type of video processing service in the request is stabilizing camera motion among the video frames of the video.

29. The system of claim 28, wherein stabilizing camera motion among the video frames of the video comprises applying camera motion estimation to the video frames of the video, the camera motion being estimated by the selected computing devices processing the video chunks of the video.

30. The system of claim 24, wherein the post-processing module is further for providing the assembled video chunks responsive to a request.

31. The method of claim 1, wherein balancing the workload of processing video chunks in parallel comprises redistributing a plurality of video chunks assigned to a video processing module to another video processing module.
